(19) United States
(12) Patent Application Publication
(10) Pub. No.: US 2012/0079805 A1
(43) Pub. Date: Apr. 5, 2012

(54) THRUST REVERSER ASSEMBLY

(76) Inventors: Alan Roy Stuart, Cincinnati, OH (US); John Robert Fehrmann, Loveland, OH (US)

(21) Appl. No.: 13/247,596

(22) Filed: Sep. 28, 2011

Related U.S. Application Data
(60) Provisional application No. 61/388,360, filed on Sep. 30, 2010.

(51) Int. Cl. F02K 3/02

(52) U.S. Cl. 60/226.2

(57) ABSTRACT

A thrust reverser assembly includes a first cowl member and a second cowl member repositionable relative to the first cowl member and operable to open a gap between the first cowl member and the second cowl member. A movable member is in supported connection with the second cowl member. The movable member is passively actuatable to move between a generally axially extending disposition and a generally radially extending disposition to direct bypass airflow of a turbofan engine.

### CROSS REFERENCE TO RELATED APPLICATIONS

This patent application claims priority to U.S. Provisional Patent Application No. 61/388,360 filed Sep. 30, 2010, which is incorporated by reference herein in its entirety.

### BACKGROUND

Exemplary embodiments disclosed herein relate generally to turbofan engine assemblies, and more particularly to a thrust reverser assembly that may be utilized with a turbofan engine.

Turbofan engine assemblies may include a fan assembly, a core gas turbine engine enclosed in an annular core cowl, and a fan nacelle that surrounds a portion of the core gas turbine engine. The fan nacelle is generally spaced radially outward from the annular core cowl such that the core cowl and the fan nacelle form a fan duct terminating in a fan exit nozzle.

Some turbofan engine assemblies include a thrust reverser assembly. The thrust reverser assembly may include a first fixed cowl and a second cowl that is axially translatable with respect to the first cowl.

In blocker-door type thrust reversers, doors or panels are actively moved into the fan duct as the thrust reverser is deployed through drag links or other mechanical means to block or impede the flow of fan air through the fan exit nozzle. Fan air may be diverted to provide reverse thrust for example through a series of turning vanes disposed in a cascade box.

Blocker-door-less type thrust reversers are typically used for small commercial engines with moderate bypass ratios. In blocker-door-less type thrust reversers, the geometry of the core cowl cooperates with a surface of the translatable cowl to block or impede the flow of fan air through the exit nozzle when the thrust reverser is deployed.

Current blocker-door-less thrust reversers are not practical for turbofan engines having increased bypass ratios. Blocker-door type thrust reversers incur weight and performance penalties through the use of drag links or other mechanisms. Accordingly, it would be desirable to have a hybrid design that provides thrust-reversing capability for a bypass turbofan engine that incorporates mechanical simplicity.

### BRIEF DESCRIPTION OF EXEMPLARY EMBODIMENTS

The above-mentioned need or needs may be met by exemplary embodiments described herein.

In one aspect, a thrust reverser assembly includes a first cowl member and a second cowl member repositionable relative to the first cowl member and operable to open a gap between the first cowl member and the second cowl member. The thrust reverser further includes a movable member in supported connection with the second cowl member, wherein the movable member is passively actuatable to move between a generally axially extending disposition and a generally radially extending disposition.

In another aspect, an assembly includes a thrust reverser assembly including a first cowl member and a second cowl member repositionable relative to the first cowl member and operable to open a gap between the first cowl member and the second cowl member, and a movable member in supported connection with the second cowl. The movable member is passively actuatable to move between a generally axially extending disposition and a generally radially extending disposition. The assembly further includes a core cowl for a gas turbine engine. The core cowl has an outer surface having a geometry adapted to cooperate with the thrust reverser assembly to define at least a portion of a fan duct, wherein the movable member is operable to move radially into the fan duct to inhibit air flow therethrough.

In yet another aspect, a method includes repositioning a second cowl member relative to a first cowl member from a stowed position to a fully translated position to form a gap between the first and second cowl members. The second cowl member forms at least a portion of a fan duct. The method includes passively actuating a movable member mounted in supported connection with the second cowl member from a generally axially extending disposition to a generally radially extending disposition to inhibit air flow through the fan duct. The method further includes directing the air flow through the gap formed between the first and second cowl members to provide reverse thrust when the moveable member is in the generally radially extending disposition.

### BRIEF DESCRIPTION OF THE DRAWINGS

The present disclosure may be best understood by reference to the following description taken in conjunction with the accompanying drawing figures.

FIG. 1 is a schematic view, either plan or side depending on installation, of an exemplary turbofan engine assembly including an exemplary thrust reverser assembly.

FIG. 2 is a side schematic view showing an exemplary thrust reverser assembly in a stowed disposition.

FIG. 3 is a side schematic view showing an exemplary thrust reverser assembly in a fully deployed disposition.

FIG. 4 is a schematic representation of certain features of an exemplary thrust reverser assembly illustrating a movement of the translatable cowl and a movable member.

FIG. 5 is a cross-sectional view of an exemplary damper structure.

FIG. 6 is a side schematic representation comparing certain features of an exemplary thrust reverser assembly with features of another thrust reverser.

### DETAILED DESCRIPTION

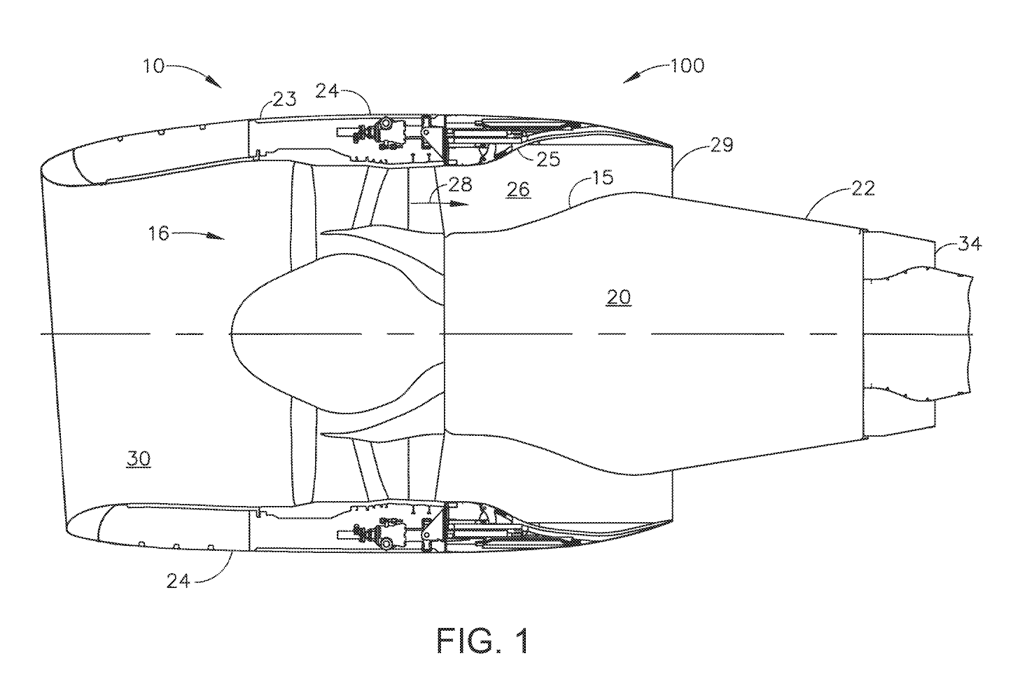

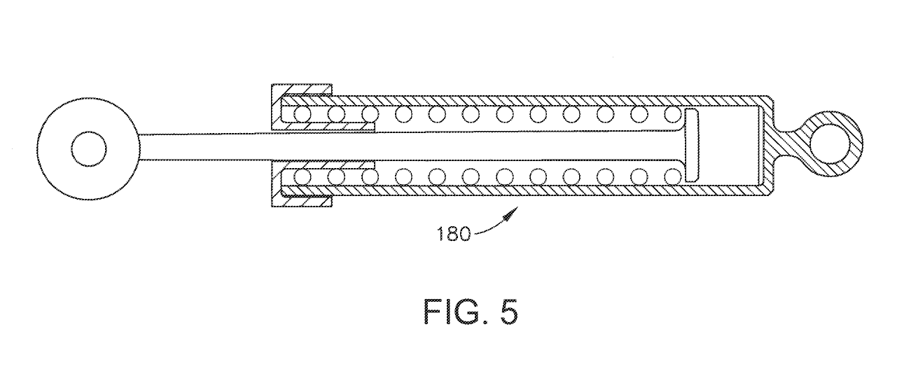

Description of exemplary embodiments disclosed herein is made with reference to the accompanying FIGS. 1-6. In the exemplary embodiments disclosed herein, it will be understood by those with skill in the art that an exemplary translatable cowl member 102 is supported in movable relationship to slider tracks or the like, that are not further described herein.

FIG. 1 shows an exemplary turbofan engine assembly 10. In an exemplary embodiment, turbofan engine assembly 10 includes a core gas turbine engine 20. In an exemplary embodiment, turbofan engine assembly 10 includes an annular core cowl 22 that extends around core gas turbine engine 20 and includes a radially outer surface 15. Turbofan engine assembly 10 also includes an inlet 30, a first outlet 29, and a second outlet 34.

In one embodiment, fan cowl, or turbofan nacelle, 24 surrounds fan assembly 16 and is spaced radially outward from core cowl 22. Nacelle 24 includes a radially outer surface 23 and a radially inner surface 25. A fan duct 26 is generally defined between radially outer surface 15 of core cowl 22 and radially inner surface 25 of nacelle 24.

During operation, airflow enters inlet 30, flows through fan assembly 16, and is discharged downstream. A first portion of the airflow is channeled through core gas turbine engine 20, compressed, mixed with fuel, and ignited for generating combustion gases which are discharged from core gas turbine engine 20 through second outlet 34. In forward thrust operations, a second portion of the airflow 28 is channeled downstream through fan duct 26 and is discharged from fan duct 26 through first outlet 29, also referred to as a fan exit nozzle. In an exemplary embodiment, nacelle 24 includes a thrust reverser assembly 100 as described in greater detail below.

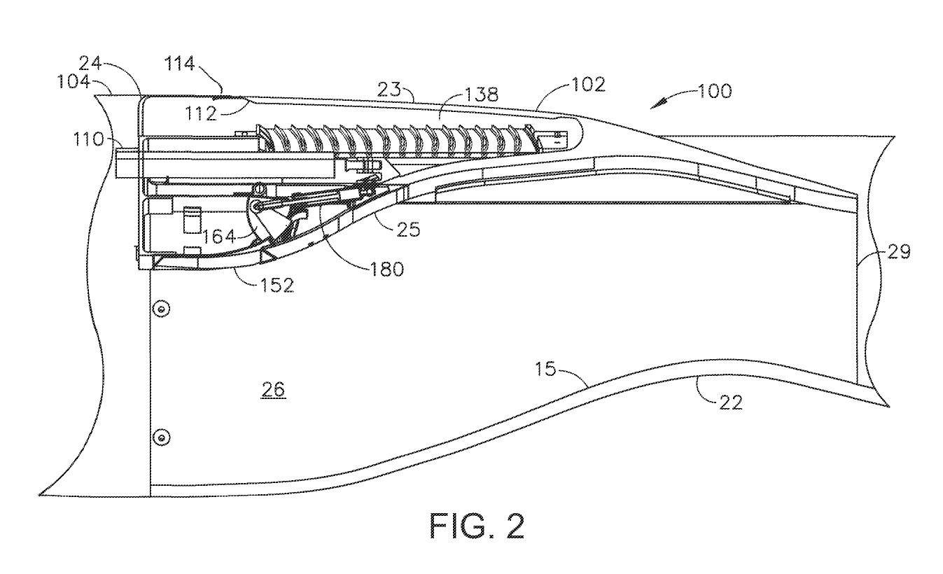

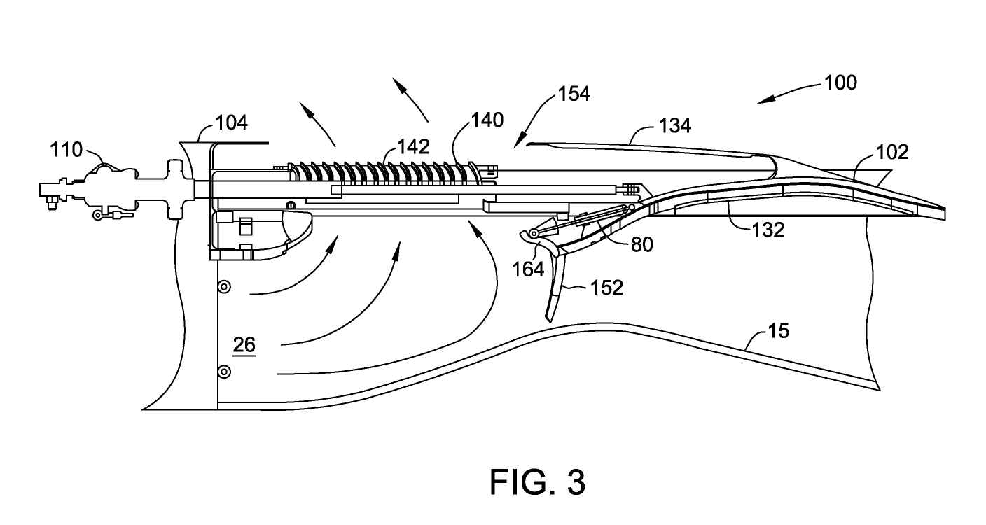

With reference to FIGS. 2-4, in an exemplary embodiment, thrust reverser assembly 100 includes a translatable cowl member 102 that defines a portion of nacelle 24. In the exemplary embodiment, translatable cowl member 102 is movably coupled to a stationary first cowl member 104. FIG. 2 shows a partial sectional side view of an exemplary embodiment having the translatable cowl member 102 in a first operational position (i.e., a stowed position). FIG. 3 is a partial sectional side view of an exemplary embodiment showing the translatable cowl member 102 in a second operational position (i.e., fully translated), wherein a movable member 152 is oriented generally radially. As illustrated in FIG. 3 in an exemplary manner, when translatable cowl member 102 is disposed in the fully translated operational position, a gap 154 is opened up between the first cowl member 104 and the translatable cowl member 102.

When the translatable cowl member 102 is fully translated, the movable member 152 is able to passively extend radially into the fan duct 26 to block or impede fan air from flowing through fan exit nozzle 29 (see FIG. 1) so that fan air is directed through thrust reverser member 140 and is turned by turning vanes 142 to provide reverse thrust (i.e., full deployment of thrust reverser assembly).

In an exemplary embodiment, an actuator assembly 110 is coupled to translatable cowl member 102 to selectively translate cowl member 102 in a generally axial direction relative to first cowl member 104. In the exemplary embodiment, actuator assembly 110 is positioned within a portion of the area defined by nacelle 24. In the exemplary embodiment, actuator assembly 110 may be electrically, pneumatically, or hydraulically powered in order to translate cowl member 102 between the operational positions.

An exemplary embodiment includes a first cowl member 104 including an aft portion 114 and a translatable cowl member 102 including a forward portion 112 sized and/or configured to be telescopingly received within the aft portion 114 of the first cowl member 104. Embodiments employing movable member 152 do not necessarily require a telescoping engagement between first cowl member 104 and translatable cowl member 102. For example, first cowl member 104 and translatable cowl member 102 may incorporate other joint or abutting means as an alternative to the telescoping engagement.

As illustrated, the translatable cowl member 102 is operably movable with respect to the first cowl member 104 between a fully stowed position (e.g., as shown in FIG. 2) and a fully translated position (e.g., as shown in FIG. 3). In an exemplary embodiment, the translatable cowl member 102 is sized and/or configured to cooperate with the core cowl 22 to define at least a portion of a fan duct 26 having an exit nozzle 29.

With particular reference to FIG. 2, an exemplary translatable cowl member 102 includes a radially inner panel 132 and a radially outer panel 134 being arranged and configured to define a space 138 therebetween. The exemplary embodiment also includes a thrust reverser member 140 positioned relative to the space 138 between the radially inner and outer panels 132, 134, respectively, so as to be selectively covered and uncovered by the translatable cowl member 102. Thus, when the translatable cowl member 102 is disposed in the stowed operational position, the thrust reverser member 140 is covered, and when the translatable cowl member 102 is in the fully translated operational position, the thrust reverser member 140 is uncovered. Appropriate flow directing members and seals may be utilized in the exemplary embodiments to provide a sealing (e.g., air tight) engagement among components. In an exemplary embodiment, thrust reverser member 140 is a fixed cascade structure including a plurality of cascade turning vanes 142 (FIG. 3).

In operation, when the translatable cowl member 102 is in the stowed operational position, air in the fan duct 26 is generally directed out of exit nozzle 29 in a forward thrust operation. To provide reverse thrust, the translatable cowl member 102 may be moved into the fully translated operational position whereby the thrust reverser member 140 is uncovered and airflow is directed through the turning vanes 142.

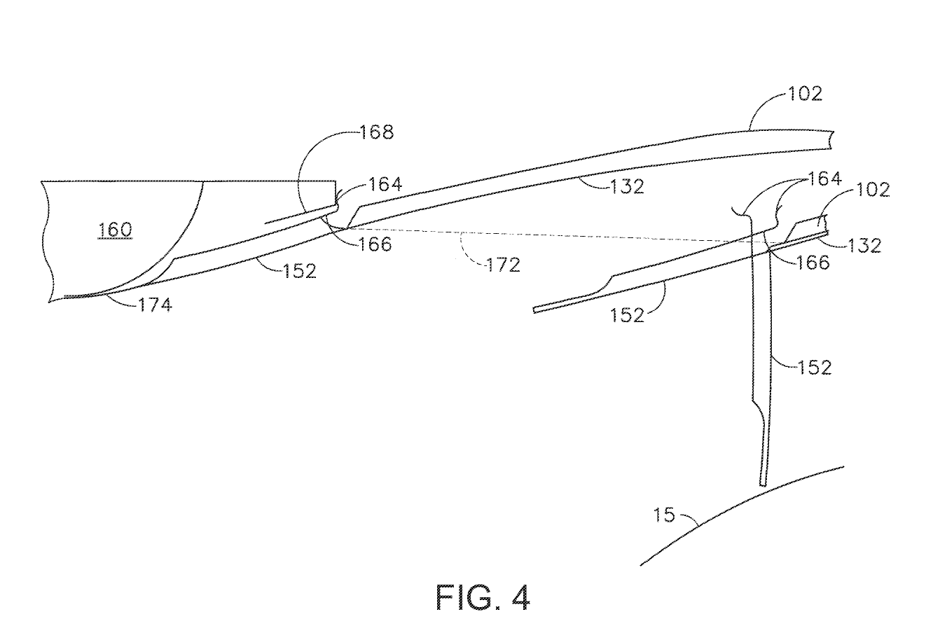

With particular reference to FIG. 4, in an exemplary embodiment, movable member 152 is carried in hinged relationship at the forward portion of radially inner panel 132. Spring/cam mechanism 164 cooperates with bracket 168 to hold movable member 152 in a stowed position that may be adjacent a fixed structure 160 forming a part of the thrust reverser assembly 100. In an exemplary embodiment, a fixed structure 160 such as a torque box or diverter fairing is sized and configured to provide a recess 174 for seating at least an end portion of the movable member 152 in the stowed position. When the thrust reverser assembly 100 is deployed, translatable cowl member 102 moves aft. The movable member 152 is disengaged from the fixed structure 160. Upon sufficient air loading, member 152 moves into a substantially radially extending disposition.

Member 152 is operable to move radially by turning about hinge 166 when acted upon by sufficient air load when the thrust reverser assembly is fully deployed and the engine power and airflow is increased. As illustrated in FIG. 4 in an exemplary manner, movable member 152 cooperates with radially outer surface 15 to block or impede airflow through the fan exit nozzle, and instead the airflow is directed through the thrust reverser structure 140 and is turned by turning vanes 142 to provide reverse thrust (FIG. 3). Thus, movable member 152 is passively activated (e.g., by airflow) rather than being actively rotated by a mechanical actuator or other mechanism.

An exemplary embodiment includes a damper structure 180, such as the spring damper mechanism 80 and 180 illustrated in FIGS. 2, 3 and 5. The damper structure 180 may be utilized to provide snubbing and avoid aero-elastic instability in the movable member 152. The illustrated spring damper mechanism is exemplary only and other mechanisms able to perform similar functions may be utilized. For example pneumatic, visco-fluid, electric, or friction mechanisms may be employed as those having skill in the art will readily appreciate.

When the thrust reverser assembly is returned to a stowed position (i.e., forward translation of the translatable cowl member 102), spring/cam mechanism 164 carried on movable member 152 engages with one or more brackets 168 on fixed structure 160 to flip the movable member 152 to the stowed orientation.

FIG. 4 illustrates movement of an exemplary translatable cowl member 102 along path 172. Movable member 152 may be in a stowed position adjacent structure 160 along recess 174, it may be in an aft, unloaded position, or it may be rotated radially by the air load to substantially block the fan duct.

In one embodiment, damper structure 180 is sized and/or configured to return movable member 152 to the axial position at low fan flow (e.g., reverse idle) and allow the movable member to seek the radial position at high fan flow (e.g., maximum reverse fan flow).

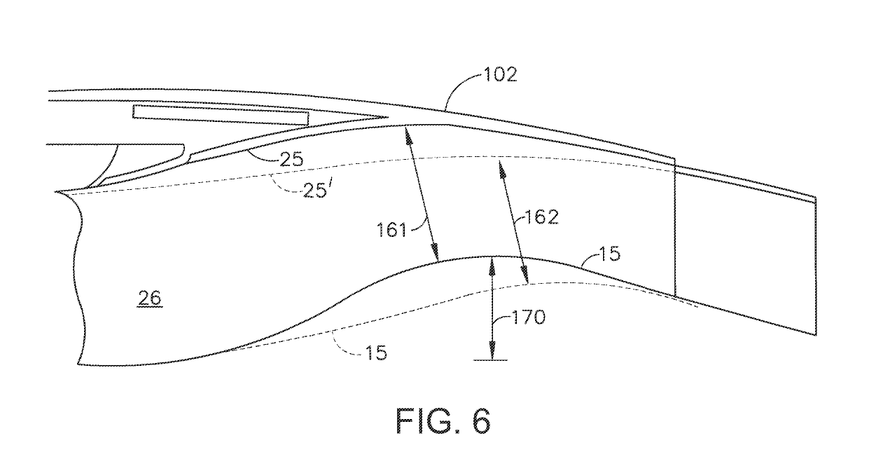

FIG. 6 provides a comparison of the area of a fan duct defined by translatable cowl member 102 and the radially outer surface 15 of the core cowl. This area, illustrated by Arrow 161, extends between radially inner surface 25 and radially outer surface 15. Typical blocker-door type thrust reverser arrangements may provide a fan duct area illustrated by arrow 162 which extends between an ordinary radially inner surface 25′ and ordinary radially outer surface 15′, as shown in FIG. 6. In an exemplary embodiment, arrow 161 represents a fan duct area substantially the same, or generally comparable in size, to the fan duct area represented by arrow 162.

Core cowl offset, in an exemplary embodiment, is illustrated by arrow 170. The term “core cowl offset” is used in this context to reference the maximum radial height of the outer surface 15 of the core cowl. Those with skill in the art will appreciate that the offset is provided by the core cowl. The exemplary core cowl offset is generally greater than the core cowl offset found in typical blocker-door type thrust reverser arrangements, but generally less than known blocker-door-less thrust reverser arrangements.

Those having skill in the art will appreciate that provision and operation of one movable member 152 has been described herein. However, exemplary embodiments include a plurality of movable members 152 spaced in circumferential orientation along the translatable cowl member 102, with each movable member 152 having corresponding spring damper mechanisms and brackets.

Further, those with skill in the art will appreciate that the exemplary embodiments disclosed herein provide desired mechanical simplicity while incorporating the benefits of fixed cascade type translating cowl thrust reversers. Technical effects of the present disclosure include passive actuation of the movable member(s) 152 to provide the ability to eliminate drag links required in blocker door type thrust reversers. The partial fan duct offset allows low duct Mach numbers and minimal nacelle diameters. The exemplary embodiments disclosed herein may be adapted to accommodate various by-pass ratios in turbofan engines.

In some embodiments, the systems and method disclosed herein may be facilitated by a computer or stored on a computer readable medium.

The embodiments described herein are not limited to any particular system controller or processor for performing the processing of tasks described herein. The term controller or processor, as used herein, is intended to denote any machine capable of performing the calculations, or computations, necessary to perform the tasks described herein. The terms controller and processor also are intended to denote any machine that is capable of accepting a structured input and of processing the input in accordance with prescribed rules to produce an output. It should also be noted that the phrase “configured to” as used herein means that the controller/processor is equipped with a combination of hardware and software for performing the tasks of embodiments of the invention, as will be understood by those skilled in the art. The term controller/processor, as used herein, refers to central processing units, microprocessors, microcontrollers, reduced instruction set circuits (RISC), application specific integrated circuits (ASIC), logic circuits, and any other circuit or processor capable of executing the functions described herein.

The embodiments described herein embrace one or more computer readable media, including non-transitory computer readable storage media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Aspects of the disclosure transform a general-purpose computer into a special-purpose computing device when configured to execute the instructions described herein. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

A computer or computing device such as described herein has one or more processors or processing units, system memory, and some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

This written description uses various embodiments to disclose the invention, including the best mode, and also to enable any person skilled in the art to practice the invention, including making and using any devices or systems and performing any incorporated methods. The patentable scope of the invention is defined by the claims, and may include other embodiments that occur to those skilled in the art. Such other embodiments are intended to be within the scope of the claims if they have structural elements that do not differ from the literal language of the claims, or if they include equivalent structural elements with insubstantial differences from the literal languages of the claims.

What is claimed is:

1. A thrust reverser assembly comprising:
a first cowl member;
a second cowl member repositionable relative to the first cowl member and operable to open a gap between the first cowl member and the second cowl member; and
a movable member in supported connection with the second cowl member, wherein the movable member is passively actuatable to move between a generally axially extending disposition and a generally radially extending disposition.

2. The thrust reverser assembly according to claim 1, wherein the second cowl member is repositionable from a stowed position adjacent the first cowl member into a fully translated position, wherein when the second cowl member is in the fully translated position, the gap is formed between the first and second cowl members.

3. The thrust reverser assembly according to claim 2 wherein the second cowl member is further repositionable into at least one partially translated position, wherein when the second cowl member is in the at least one partially translated position, the gap is not formed between the first and second cowl members.

4. The thrust reverser assembly according to claim 1 wherein the first cowl member includes an aft portion and the second cowl member includes a forward portion being sized and/or configured to be telescopingly received within the aft portion of the first cowl member.

5. The thrust reverser assembly according to claim 1 further comprising a damping structure operably connected to the movable member.

6. The thrust reverser assembly according to claim 1, wherein the damping structure is sized and/or configured to maintain the second cowl member in the axially extending disposition at a first fan flow amount, and to allow the second cowl member to move to the generally radially extending disposition at a second fan flow amount that is greater than the first fan flow amount.

7. An assembly comprising:
a thrust reverser assembly comprising a first cowl member and a second cowl member repositionable relative to the first cowl member and operable to open a gap between the first cowl member and the second cowl member; and a movable member in supported connection with the second cowl member, wherein the movable member is passively actuatable to move between a generally axially extending disposition and a generally radially extending disposition; and
a core cowl for a gas turbine engine, wherein the core cowl has an outer surface having a geometry configured to cooperate with the thrust reverser assembly to define at least a portion of a fan duct, wherein the movable member is operable to move radially into the fan duct to inhibit air flow through the fan duct.

8. The assembly according to claim 7, including a fixed structure sized and/or configured to provide a recess for seating at least a portion of the movable member.

9. The assembly according to claim 8, wherein the fixed structure is a torque box or a diverter fairing.

10. The assembly according to claim 7, wherein the first cowl member includes an aft portion, and the second cowl member includes a forward portion that is sized and/or configured to be telescopingly received within the aft portion of the first cowl member.

11. The assembly according to claim 7, wherein the core cowl has an offset sized and/or configured to cooperate with the movable member to inhibit air flow through the fan duct when the movable member is in the radially extending disposition.

12. The assembly according to claim 7, further including a damping structure operably connected to the movable member.

13. The assembly according to claim 12, wherein the damping structure is sized and/or configured to maintain the second cowl member in the axially extending disposition at a first fan flow amount, and to allow the second cowl member to move to the generally radially extending disposition at a second fan flow amount that is greater than the first fan flow amount.

14. A method comprising:
repositioning a second cowl member relative to a first cowl member from a stowed position to a fully translated position to form a gap between the first and second cowl members, wherein the second cowl member forms at least a portion of a fan duct;
passively actuating a movable member mounted in supported connection with the second cowl member from a generally axially extending disposition to a generally radially extending disposition to inhibit air flow through the fan duct; and
thereafter, directing the air flow through the gap formed between the first and second cowl members to provide reverse thrust when the moveable member is in the generally radially extending disposition.

15. The method according to claim 14, further comprising providing a fixed structure sized and/or configured to provide a recess for seating at least a portion of the movable member.

16. The method according to claim 14, wherein the fixed structure is a torque box or a diverter fairing.

17. The method according to claim 14, further comprising telescopingly receiving a forward portion of the second cowl member, that is sized and/or configured to be within the aft portion of the first cowl member, in the aft portion of the first cowl member.

18. The method according to claim 14, wherein the core cowl has an offset sized and/or configured to cooperate with the movable member to inhibit air flow through the fan duct when the movable member is in the radially extending disposition.

19. The method according to claim 14, further comprising providing a damping structure operably connected to the movable member.

20. The method according to claim 19, wherein the damping structure is sized and/or configured to maintain the second cowl member in the axially extending disposition at a first fan flow amount, and to allow the second cowl member to move to the generally radially extending disposition at a second fan flow amount that is greater than the first fan flow amount.
